(19) United States
(12) Patent Application Publication
(10) Pub. No.: US 2013/0304520 A1
(43) Pub. Date: Nov. 14, 2013

(54) METHOD FOR ACTIVATING AN INSURANCE POLICY ONLINE AND DEVICE FOR CARRYING OUT SAID METHOD

(71) Applicants: Jürg Ralph Ernst, Wollerau (CH); Heinz Ernst, Russikon (CH)

(72) Inventors: Jürg Ralph Ernst, Wollerau (CH); Heinz Ernst, Russikon (CH)

(21) Appl. No.: 13/976,416

(22) PCT Filed: Dec. 23, 2011
(86) PCT No.: PCT/IB11/55945

§ 371 Date: Jul. 24, 2013

(30) Foreign Application Priority Data
Dec. 30, 2010 (CH) 02191/10

(51) Int. Cl. G06Q 40/08

(52) U.S. Cl. CPC G06Q 40/08
USPC 705/4

(57) ABSTRACT

A method for the computer-assisted activation of an insurance certificate for vehicles on a homepage is described, in which the policyholder himself is authorized to access a clearing system of the insurance, in order to the able to prepare an electronic insurance certificate and send it electronically directly to the permitting authorities, after which the policyholder is automatically requested to retrieve the license plates and the vehicle registration document at the permitting authorities. With this method, a policy of other insurances can also be electronically transacted, including the electronic payment and the electronic preparation of the policy and the electronic automated claim regulation.

The invention relates to methods for the computer-assisted activation of an insurance policy on a homepage according to Claim 1 and a device for the computer-assisted activation of an insurance policy according to Claim 8.

### PRIOR ART

A method and a system for the online processing of life insurance is known from U.S. Pat. No. 7,765,115, in the case of which data about the person to be insured and the insurability of this person are obtained. A certificate can be received via an electronic data exchange, which confirms whether an insurance certificate was sent to the insurance receiver. Furthermore, information from a third party can be received via an electronic data exchange, which confirms the identity of the person to be insured. When a commitment is received that the insurance has been purchased, a personalized preliminary insurance certificate is output to the insurance receiver. An authorization can also be obtained via an electronic data exchange, so that medical information about the person to be insured can be retrieved directly by one or more third parties.

In the case of this method, the data are exchanged via the Internet and a Web server, a data server, and a processing server for the insurance queries are provided. The communication with the servers occurs via PCs, mobile telephones, or PDAs.

In the case of the present method, various information is retrieved from third parties and the preliminary insurance certificate is exclusively activated by the respective insurance company.

### OBJECT OF THE INVENTION

The present invention is based on the object of providing a method, in the case of which the insurance policy can be prepared in a simpler and more cost-effective manner and can be activated by the policyholder himself.

### SUBJECT MATTER OF THE INVENTION

This object is achieved by a method having the features of Patent Claim 1 and by a device having the features of Patent Claim 8.

The invention has the great advantage that the policyholder can independently generate an insurance policy entirely electronically independently without an external check by an insurance company, for example. The processing is therefore performed exclusively by the policyholder, without an insurance company, an insurance agent, or an insurance broker having to engage in the process. Databank queries are also no longer necessary in order to check the identity of the policyholder, since in the case of the response to the application questions, for example, the number of the drivers license must be input and stored and, on the other hand, a further plausibility check of the customer is performed automatically by the check of the credit card by the corresponding provider.

The invention also includes the fully automatic processing of insurance contracts from the application acceptance including the associated electronic processing of the underwriting via the payment by means of credit card to the automatic, electronic transmission of the insurance policy in the independent customer dossier in PDF format. Using this electronic dossier, in which the customer can manage, amend, cancel, or also expand his own contracts at any time, the customer has the advantage that he can view and manage his entire insurance portfolio at any time, since he has access at any time and worldwide. The invention additionally has the further advantage that specific defined claims are settled within seconds with disclosure of the claim number for the customer with the filing of the statement of damage, and in certain cases in the case of the claim regulation, the claim payment is credited directly to the credit card stored by the customer.

The customer can also, if he has completed and paid for a policy via the portal to be transacted and protected, can also upload policies from third-party providers in PDF format and after he has input some information, for example, policy number, premium, expiration date, company, etc., can manage them in his customer center. With a button press, the customer then receives a detailed overview over all of his existing policies in the form of a detailed policy overview, in which, in addition to insurance company, maturity, main expiration, expiration date, yearly premium, and policy number, he can also retrieve, amend, and manage further important information at any time. The claim processing is also fully automated. After the customer has logged into his customer center, he can electronically report the claim to the insurer. In the case of fully automated claim settlement, immediately after the electronic application of the claim, the customer has a letter with the claim number delivered directly from the system, from which it is obvious that the customer only still has to file the invoice for payment to the insurer with specification of the claim number.

If the signature of the customer is required for legal reasons, after the electronic claim report of the customer to the insurer, the immediate transmission of the claim number through the system is performed and the information is provided in a letter, which the customer must still send conventionally in undersigned form via post to the insurer, as a claim notice which is saved and stored in the customer center as a PDF.

In addition, the entire claim regulation process is entered by the claim-regulating insurer in the customer center of the customer. If the insurer performs a claim regulation, for example, this is also registered by the insurer in the customer center. As a consequence, an e-mail is triggered from the customer center directly to the customer at the e-mail address stored by the customer, which notifies him that he is to log into his customer center since he has received a message. When he has then logged in, he sees, for example, the settlement message of the insurer, which states that the invoice of the garage owner is paid and the claim is settled. Therefore, the customer is informed at all times about the status of the claim processing. Finally, claim payments are sometimes performed, depending on the type of claim, the extent, and the level, directly via the credit card specified by the customer. In this case, an e-mail is sent to the customer at the stored e-mail address, which requests that the customer once again specify or confirm his credit card, respectively, so that the claim payment can be performed directly to his specified credit card.

### DESCRIPTION OF AN EXEMPLARY EMBODIMENT OF THE INVENTION

Further advantages of the invention result from the dependent patent claims and from the following description, in which the invention is explained in greater detail on the basis of an exemplary embodiment shown in the schematic figures. In the figures:

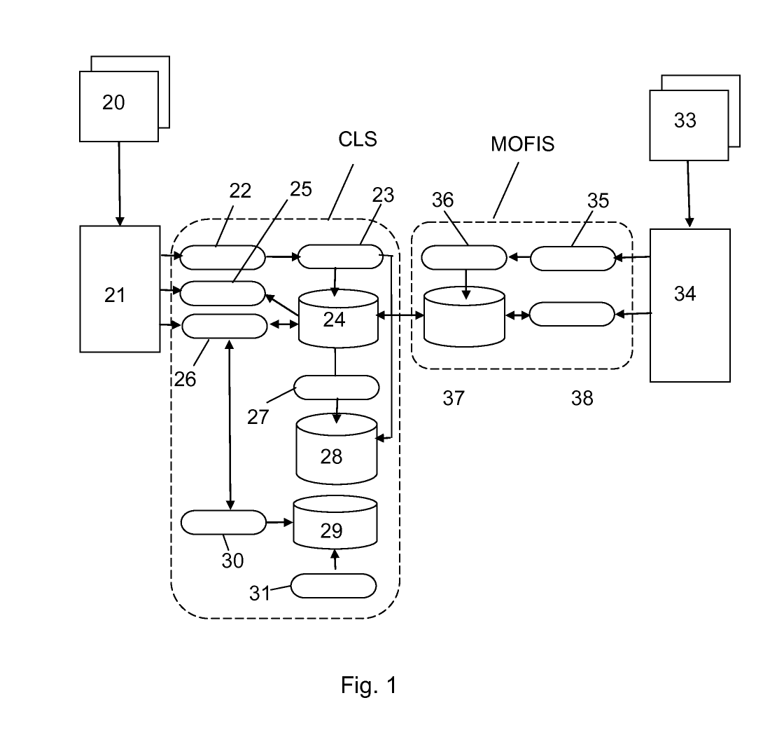

FIG. 1 shows an illustration of the data exchange between the clearing system of the insurance company and the motor vehicle information system of the authorities,

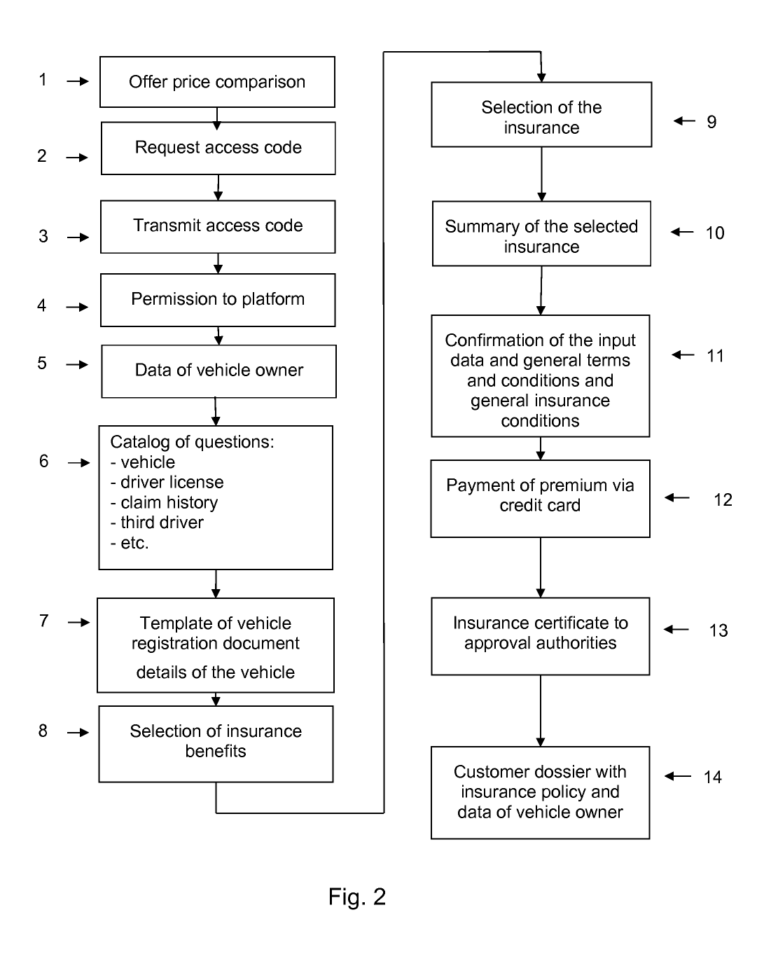

FIG. 2 shows the method steps for the computer-assisted activation of an electronic insurance certificate,

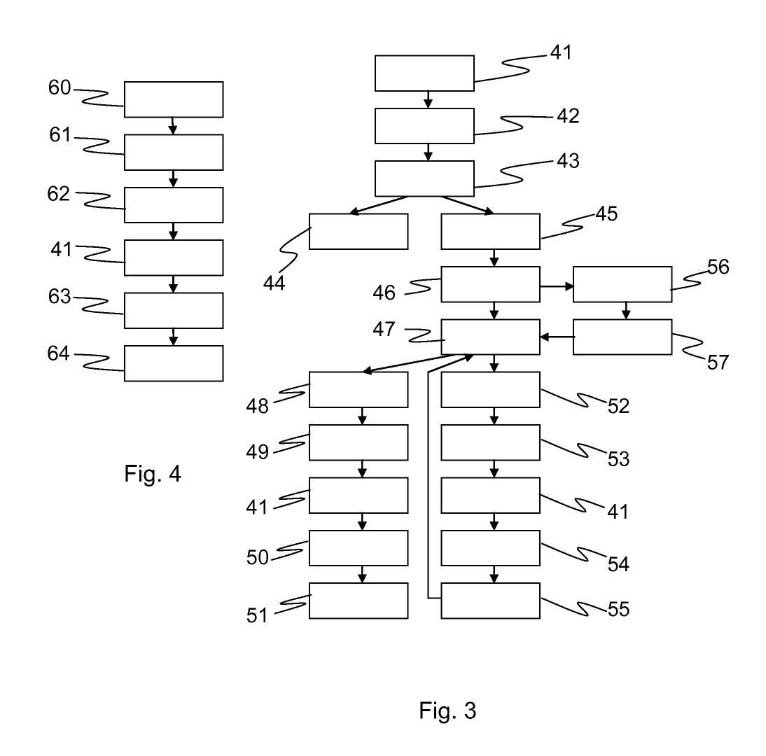

FIG. 3 shows the sequence in the event of a claim report by a customer,

FIG. 4 shows the sequence in the event of a reopening of the claim dossier,

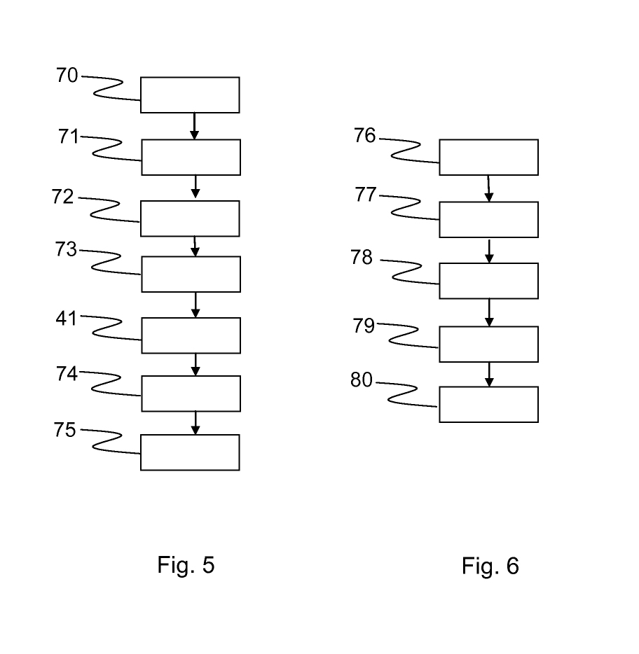

FIG. 5 shows the sequence in the event of a claim report by the insurer,

FIG. 6 shows the sequence in the event of a claim report by the injured party or his car repair shop,

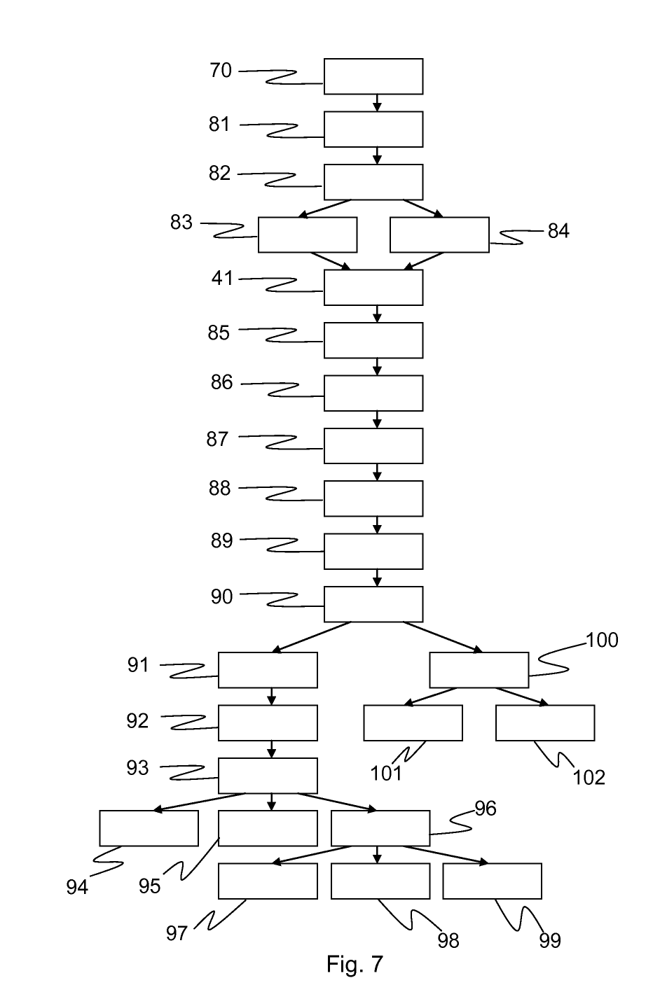

FIG. 7 shows the sequence in the event of a cancellation in the case of a claim for which compensation is required by the customer, and

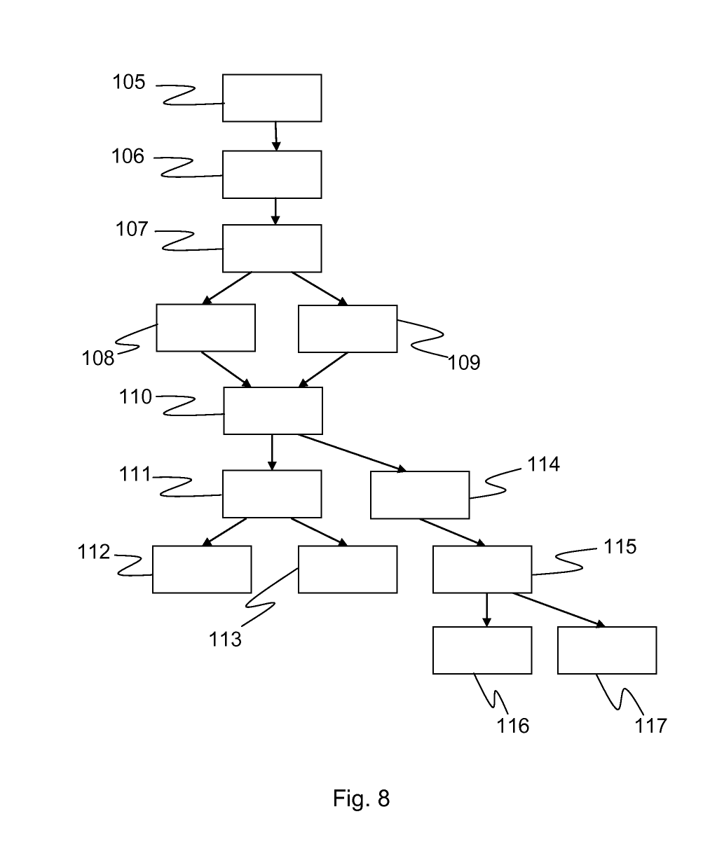

FIG. 8 shows the sequence in the event of a cancellation in the case of a claim for which compensation is required by the insurer.

The invention is based on the idea that the potential policyholder must first apply and store his e-mail address in order to, after inputting the received release code, have to fill out a catalog of questions according to predefined criteria, in order to be permitted into the system. Once he has been permitted, he can execute all required steps independently, in order to insure a vehicle, for example, in that an insurance certificate is sent completely electronically to the responsible permitting authorities and the required vehicle registration number and the associated vehicle registration document can be retrieved directly from the approval authority. In a later phase, he can also perform amendments to the vehicle data independently and send a claim report completely electronically to the insurer. The system automatically generates an e-mail to the registered policyholder with the claim number in the event of a claim report. In the case of specific claims, the claim settlement is performed directly upon the input, in that the system communicates to the policyholder that he can present the claim invoice directly to the insurer for payment. From the electronic receipt of the application up to the preparation of the electronic policy in PDF format to the issuance of the international certificate of insurance (“green card”) and the electronic claim regulation up to the claim payment (in predetermined cases) to the stored credit card, all of this is performed completely electronically without intervention by an employee of the insurance company or the insurance broker.

The data exchange between insurance companies and the permitting authorities for vehicle registration documents in Switzerland has been performed recently via a new clearing system (CLS), which is a protected information system, wherein every insurance company exclusively has access to its own information (insurance certificates, etc.).

The Swiss Federal Office of Transport (ASTRA) exchanges motor vehicle data and motor vehicle owner data with the cantonal permitting authorities of Switzerland based on a motor vehicle information system (MOFIS), as shown in FIG. 1. From the decentralized system databanks 20 of an insurance company, which are shown on the right, the data are stored in a central system 21 of the insurance company, which is connected via the clearing system CLS to the motor vehicle information system MOFIS of the permitting authorities. The clearing system CLS includes a search interface 22, which can access a databank 24 having electronic insurance certificates via a search function 23. This databank 24 then outputs feedback 25 about the registration, cancellation of registration, canton change, owner change, vehicle change, etc., and about the current insurance company to the central system 21. Furthermore, there is a check function 26, which checks the electronic insurance certificate and confirms the receipt in the databank 24 to the central system 21. The electronic insurance certificate is additionally received in an archive databank 28 via an archiving task 27. The data of the user, which are organized by means of a user administration 30, are stored in a further user databank 29. Authorized users can access the clearing system CLS by means of an access check 31. The decentralized systems 33 of the permitting authorities are shown on the right. These are connected to the central system 34 of the permitting authorities, which can in turn access the MOFIS. Via a search interface 35, a search function 36 is activated, whereby a search can be made in a databank 37 of the registered motor vehicles. The reports 38 of the registration/cancellation of registration, canton change, owner change, vehicle change, etc. are relayed from the central system 34 to the databank 37, on the one hand, and are received from this databank 37 in the central system 34, on the other hand.

In the event of an enrollment of a motor vehicle, the responsible liability insurer confirms, by the issuance of an insurance certificate, the existence of valid insurance protection. The insurance certificate is submitted to the responsible cantonal permitting authorities prepared in electronic form and transferred to the clearinghouse, which transfers the electronic insurance certificate on request to the system MOFIS. The electronic insurance certificate is additionally archived in the system CLS of the clearinghouse. The registrations and cancellations of registrations (IV/AV) of the permitting authorities arrive via the system MOFIS in the clearing system CLS and are transferred on request to the insurance companies. The permitting authorities no longer deliver report codes (grounds for IV/AV). These are derived by MOFIS from the data provided by the highway traffic authorities.

The communication between the insurance companies and the permitting authorities is coordinated by the system CLS and the system MOFIS. Since the insurance companies exclusively communicate with their server of the CLS and the permitting authorities exclusively communicate with their server of the MOFIS, the technology dependence is very low. The communication between the insurance companies and the system CLS occurs via a TCP/IP connection using HTTPS (SSL 128-bit encryption) via the Internet. The data are exchanged in XML format.

Various method steps are shown in FIG. 2, which allow an authorized policyholder to access the insurance companies directly via the clearing system CLS and therefore be able to provide an electronic insurance certificate directly to the responsible permitting authorities, so that in the event of correct transmission of the vehicle data, the permitting authorities legitimize the vehicle to the policyholder to redeem, transfer, etc., and to retrieve the vehicle registration certificate and the vehicle registration number directly from the permitting authorities. The insurance company performs a preliminary check of the insurability of the potential policyholder electronically according to specific criteria, the policyholder is authorized after a more detailed check for access to the clearing system CLS of the insurance companies.

In a first step 1, the vehicle data are input by the potential policyholder or interested parties on the homepage of the insurance provider or the vehicle portal, without indicating his identity. He then receives an offer with three different products, represented in a price and coverage comparison for the vehicle to be insured. If the interested party accepts this offer, he is requested in step 2 to register as a new customer with a username and a password while providing his e-mail address. In step 3, an access code is transmitted via e-mail to the interested party at the specified e-mail address. In step 4, the interested party inputs is access code and is thus permitted onto the platform with various services.

In a next step 5, the interested party and vehicle owner has to input his personal data, such as last name, first name, address, residence, telephone number, birthdate, nationality (in the case of foreigners, the residence permit), date of the driving test, specifications on an official document such as driver license, etc. After he has made these inputs, the interested party is requested in step 6 to answer a number of questions for risk evaluation. The answers are compared to predetermined criteria in a comparison module and in the event of correspondence, a further window appears in step 7, which forms a template for the vehicle data, in which these data such as type of the vehicle, make and model, type approval, engine displacement, color, vehicle registration number number, log number, date of first operation, fuel, original price, kilometers driven per year, intended purpose, leasing, and accessories are entered. It can also be asked of the interested party whether a shared license plate is to be insured. In this case, the window is opened once again to register the vehicle data of the second vehicle. These specifications cause an offer with three different products, represented in a price and coverage comparison for the vehicle to be insured, to be presented in step 8. The interested party now selects one of the products available for selection (silver, gold, or platinum) by clicking in step 9. In step 10, upon acceptance of the desired risk coverage by the interested party, it can once again be checked in a summary whether the owner data, the vehicle data, and the desired product were correctly input. If needed, a correction can be carried out once again in this step. If the insurance of the risk coverage does not correspond to the profile of the insurance company, a message will appear that the insurance cannot be completed online and if desired the insurance company or a cooperative partner will contact the interested party personally.

After the interested party has checked all inputs, he must confirm in step 11 that he has understood and accepted the content and language of the general terms and conditions and the general insurance conditions, and that he will transact an insurance contract which is subject to costs.

Subsequently, the interested party is requested in step 12 to pay the insurance premium selected in step 9 by means of an electronic means of payment such as credit card, mobile telephone, etc. If the payment has been accepted, an electronic insurance certificate is immediately sent in step 13 via the platform of the insurance provider via the databank 24 and the databank 37 of the MOFIS (see FIG. 1) to the permitting authorities. If the electronic means of payment (e.g., credit or debit card) is not accepted (e.g., because of a lack of funds), the electronic insurance certificate is not activated.

If all data have been successfully input and the payment of the yearly premium has been performed, in step 14, the policyholder is conducted to his personal customer dossier or customer center, in which his insurance application and his insurance policy are stored in electronic format (PDF). The international insurance card is also stored therein in electronic format (PDF) and can be downloaded by the policyholder. He is also requested automatically by means of e-mail and in the customer center to retrieve the license plates and the insurance certificate from the permitting authorities. The policyholder can also electronically input diverse amendments, for example, address changes, vehicle changes, and owner changes in his personal customer center and independently report claims electronically. In steps 13 and 14, the electronic insurance certificate can also be transmitted to the permitting authorities for all necessary cases of presentation, for example, name changes as a result of marriage, canton change, etc., by the policyholder, and the policy and the international green insurance card is therefore automatically prepared again.

So-called electronic banking (“e-banking”) can also fall under “payment by means of an electronic means of payment”. In this case, the policyholder can log off of the Internet platform after step 11 and he is requested by e-mail after the input of the payment via e-banking to log on again to the Internet platform using his access code. Steps 13 and 14 then follow, i.e., the access to his electronic customer dossier.

All cases which make an insurance certificate necessary can be carried out using the above electronic solution. For example, if a policyholder wishes to enroll the vehicle in another canton, after input of the new address, an electronic insurance certificate is automatically issued via the platform and sent electronically to the responsible permitting authorities. The system is programmed in such a manner that such amendments are processed automatically. If a more cost-effective vehicle is redeemed in the event of a vehicle change, the policyholder receives a credit pro rata, which is calculated with the premium of the new vehicle for a new insurance duration of 12 months from the redemption date. If there is still a credit in favor of the policyholder, a credit is performed to his credit card. In the event of a definitive disposal of the license plates, the return premium is refunded pro rata to the policyholder to his specified credit card. If a more expensive vehicle is redeemed, a credit is calculated for the previously insured vehicle and the credit card is debited with the differential amount for the newly redeemed vehicle for the duration of a year from the date of the vehicle change. The same procedure is also performed if there is a shared license plate policy. Since the premium in the event of vehicle change must always be paid for a year from the amendment date or redemption date, respectively, it is ensured that the required insurance certificate is always transmitted electronically.

Eight weeks before the expiration of the insurance, the policyholder is requested via e-mail to pay the renewal premium for the next insurance year by means of electronic means of payment (e.g., credit or debit card) within a predetermined deadline. If the policyholder does not comply with this request in a timely manner, a new deadline of one week is again given to him via e-mail at the stored address and via SMS on the stored telephone number, in order to perform the payment electronically. After passage of this deadline without payment of the outstanding insurance premium, his vehicle registration number is automatically canceled without further measures at the permitting authorities.

Furthermore, the policyholder can also be requested via SMS for payment, to pay the renewal premium, if the mobile telephone number of the policyholder is known. In this case, the policyholder could also trigger the payment by means of a transaction number (so-called TAN code). Such a payment also falls under the concept of “electronic payment online”. If the policyholder is not reachable via e-mail or via SMS and no premium payment is performed, the vehicle registration number is automatically canceled, so that the administrative expenditure is restricted to a minimum.

In order to illustrate such further transactions on the Internet platform, various sequences are illustrated and described hereafter as examples in FIGS. 3 to 8.

FIG. 3 shows the sequence during a claim report by the customer 40. The customer 41 logs in for this purpose in step 42 using his stored access data or access code 3, and can fill out the claim formula online in step 43. If certain fields are not filled out or are not filled out correctly, the system requests that the customer perform the required corrections before further steps can be performed. After the claim formula has been correctly filled out by the customer, it is noted in step 44 in the customer dossier that a claim has been “reported”. Simultaneously, it is reported in step 45 to the insurer via e-mail that a completely filled out claim formula has been received from the customer 41. An e-mail is immediately sent electronically to the customer after electronic reporting of the claim, in which he immediately receives the claim number and, depending on the claim, e.g., in the event of glass damage, hail damage, or damage caused by martens, he also receives the message that he should also file the invoice for payment. In the case of specific registered claims in which the insurer must request the official files, for example, after registration of the claim, an e-mail of the insurer with disclosure of the claim number is also immediately triggered. In addition, the policyholder is requested to once again print out the electronic claim report stored in the customer center as a PDF and, provided with the personal signature, to send it to the insurer. Subsequently, in the case of this claim regulation in step 46, the claim formula is checked by the insurer. In step 47, a decision is made by the insurer that either the claim amount will be directly paid out or rejected and—if a payment occurs—a corresponding remark with the amount, value, and claim number is entered by the insurer in the customer dossier in the customer center (step 48). Then, in step 49, an e-mail is sent to the customer 41 at the stored e-mail address, which states that he has received information in the customer center and should log in, so that he logs in using his access code on the Internet platform (step 50). The customer then receives the details of the claim regulation after the login in the customer center (step 51). If the decision 47 cannot yet be made, because additional information is required, the remark “in processing” is registered in the customer dossier under the claim number (step 52). An e-mail is sent to the customer (step 53), after which the customer 41 again logs in using his access code on the Internet platform (step 54), and the customer can learn in his customer dossier which additional questions of the insurer are to be answered (step 55). When all questions have been sufficiently answered, a new decision 47 is performed, which results in payment 48. If no decision has been made within a predetermined deadline of several days, which is monitored using a counter 56, an e-mail is sent to the customer service of the Internet platform, which notifies the insurer via e-mail of the still open claim (step 57). The decision 47 is then performed in turn.

Subsequently, in the case of this claim regulation in step 46, the claim formula is checked by the insurer. In step 47, a decision is made by the insurer that either the claim amount will be directly paid out or rejected and a corresponding remark with the amount, value, and claim number is entered by the insurer in the customer dossier (step 48). Then, in step 49, an e-mail is sent to the customer 41 at the stored e-mail address, who logs in using his access code on the Internet platform (step 50), after which he can receive details of the claim regulation in the customer center (step 51). If the decision 47 cannot yet be made, because additional information is required, the remark “in processing” is registered in the customer dossier under the claim number (step 52). An e-mail is sent to the customer (step 53), after which the customer 41 again logs in using his access code on the Internet platform (step 54), and the customer can learn in his customer dossier which additional questions of the insurer are to be answered (step 55). When all questions have been sufficiently answered, a new decision 47 is performed, which results in payment 48. If no decision has been made within a predetermined deadline of several days, which is monitored using a counter 56, an e-mail is sent to the customer service of the Internet platform, which notifies the insurer via e-mail of the still open claim (step 57). The decision 47 is then performed in turn.

FIG. 4 shows the sequence of a reopening of a registered claim. The reopening in step 60 represents the case if the insurer finds, based on additional information of the customer after a further decision, that the claim amount is to be paid. A report is then performed via e-mail to the customer service, which attaches the remark “reopened” to the claim in the customer dossier (step 61). An e-mail is then triggered to the customer 41 in step 62 from the Internet platform, who logs in using his access code in step 63 onto the Internet platform. In the customer center, the customer can then view his customer dossier and the feedback of the insurer (step 64).

FIG. 5 shows the sequence if a claim report is performed by the insurer 70. The insurer reports in step 71 via e-mail the claim to the customer center. In step 72, the claim procedure is then described in the customer dossier. In step 73, an e-mail is sent to the customer 41, who can log into the Internet platform using his access code in step 74. Step 75 shows the sequence according to FIG. 3, which then follows.

According to FIG. 6, an injured party or a garage owner 76 can also log onto the Internet platform and fill out a claim formula in step 77. This formula is then sent via e-mail to the insurer (step 78). The insurer then checks the filled-out formula in step 79 and assigns it to the customer or the contract. Subsequently, the sequence according to FIG. 5 is performed in step 78.

FIG. 7 shows the sequence in the event of a cancellation by the customer in the case of a claim for which compensation is required. The insurer 70 pays in step 81 the agreed-upon claim amount. A report 82 from the SID is sent via e-mail to the customer center. In step 83, the customer dossier is then updated to the current status in the customer center and in step 84 an e-mail with a corresponding message is sent to the customer. The customer 41 can then log in to the Internet platform using his access code (step 86) within a time span 85 of 14 days, and then file a cancellation in the customer center in step 87. An e-mail is then sent to the SID with the cancellation in step 88. In step 89, it is checked by the insurer whether the cancellation can be accepted. Then, in step 90, there is a feedback via e-mail to the electronic system manager, which then either accepts the cancellation in step 91 or rejects the cancellation in step 100. If the cancellation is accepted, the electronic system manager issues a confirmation of the cancellation of registration and stores this in the customer dossier (step 92). In next step 93, a report is also sent by the electronic system manager to the customer center, whereby an e-mail 94 is triggered to the customer, the customer dossier in the customer center is updated to the newest status (step 95) and the payment 96 of the premium refund is performed. After the payment 96, a report 97 is sent to the electronic system manager, whereby an e-mail 98 is sent to the customer and the customer dossier is once again updated to the newest status (step 99).

In the case in which the cancellation has been rejected in step 100, an e-mail 101 is sent to the customer and the customer dossier in the customer center is updated to the newest status (step 102).

FIG. 8 finally shows the sequence in the event of a cancellation by the insurer 105 in the case of a claim for which compensation is required. In step 106, the claim amount is paid by the insurer. This is typically performed by a bank transfer via e-banking. Subsequently, a report 107 is sent from the electronic system manager to the Internet platform, upon which in step 108 the customer dossier in the customer center is updated to the newest status and the customer is notified via e-mail 109. After unused passage of a 14-day deadline 110, a message 111 is sent to the customer center on the Internet platform. In step 112, the customer dossier is subsequently updated to the newest status, and an e-mail 113 is sent to the customer. Otherwise, after passage of the deadline 110, an electronic insurance certificate 114 is issued by the electronic system manager and stored in the customer dossier. The payment 115 of the premium refund is then performed and in step 116 the customer dossier in the customer center is updated to the newest status and an e-mail 117 is sent to the customer.

It is obvious that not only vehicle insurance can be transacted in this manner, but rather also any other type of insurance, such as household insurance, private liability insurance, building insurance, legal expenses insurance, etc. The transaction of the insurance is performed after a catalog of questions having predetermined criteria, so that the trustworthiness of the policyholder is checked here. When this hurdle has been passed, the policyholder can automatically, i.e., completely electronically, independently activate the insurance certificate, the application, and the electronic issuance of the policy and the international green insurance card. In case of a claim, the insurance is then checked as to whether the policyholder has actually carefully filled out all specifications. In the event of incorrect specifications, the legal consequences occur automatically according to the Swiss Insurance Contract Code (VVG), i.e., there is then no longer any insurance protection and the premium paid is forfeited and any claim payments performed can be requested back. The policyholder is explicitly informed of this risk in diverse steps during the transaction. Therefore, a very low and therefore calculable danger of being harmed by dubious policyholders exists for the insurer.

1. A method for the computer-assisted activation of an insurance policy on a homepage, wherein a clearing system (CLS) of an insurer, which is implemented as a protected information system, having a central databank, a user databank, a user administration and an access check is provided, and
based on specifications on the extent of insurance, an offer is made to the policyholder,
in the event of agreement, the policyholder registers with his e-mail address and an access code is sent via e-mail to the policyholder from the clearing system (CLS),
the policyholder logs in using his access code to the access check of the clearing system (CLS) and details on the policyholder and on the desired insurance are entered via the user administration into the user databank,
a catalog of questions with reference to the policyholder and the insurance is filled out and stored in the user databank,
the answers to the catalog of questions are compared to a pattern or search function in the central databank and if the answers correspond with the pattern, a template of the insurance policy appears,
an offer of the insurance benefits appears,
data of the desired extent of insurance are entered in the template,
a summary of the entered data of the insurance and the offered premium appears, which data are corrected and/or confirmed by the policyholder and stored again in the user databank,
the general terms and conditions and the general insurance conditions appear, which are confirmed together with the entered data by the policyholder,
the insurance premium is paid by means of electronic means of payment online, and
an electronic insurance policy is prepared, which is relayed online or via e-mail.

2. The method according to claim 1, wherein the insurance is a motor vehicle insurance and an electronic insurance certificate for the insurance policy is relayed online to a responsible approval authority.

3. The method according to claim 2, wherein a request is automatically sent to the e-mail address of the policyholder, to reprieve the license plates and the insurance certificate from the permitting authorities.

4. The method according to claim 2, wherein after the template of the vehicle registration document is filled out, insurance benefits are filled out, which then appear in the summary of the entered data.

5. The method according to claim 1, wherein the insurance is household insurance, private liability insurance, building insurance, or legal expenses insurance.

6. The method according to claim 1, wherein the policyholder logs in using his access code onto the homepage, reports and/or corrects a claim on an electronic claim formula, and after a check by the insurer, a claim amount is paid out automatically according to the specifications in the claim formula.

7. The method according to claim 6, wherein the claim report is performed and/or checked by the insurer on the homepage and an electronic message is sent to the policyholder.

8. The method according to claim 7, wherein the claim report is performed by an injured party on the homepage on a claim formula, and the insurer cheeks the specified damages.

9. A device for the computer-assisted activation of an insurance policy on a homepage, wherein a clearing system (CLS) of an insurer, which is implemented as a protected information system, having a central databank, a user databank, a user administration, and an access check is provided, the device having
a first window, in which an offer is made to the policyholder on the basis of specifications on the extent of insurance,
a second window, in which the policyholder registers with an e-mail address,
a third window, in which the policyholder logs in to the access check of the clearing system (CLS) using an access code sent via e-mail from the clearing system (CLS),
a fourth window, in which details on the policyholder and on the desired insurance are entered by the policyholder via the user administration into the user databank,
a fifth window, in which a catalog of questions with reference to the policyholder and to the insurance is filled out and stored in the user databank,
a sixth window, in which after correspondence of the answers to the catalog of question with a pattern or search function in the central databank, a template of the insurance policy appears,
a seventh window, in which an offer of the insurance benefits appears,
an eighth window, in which data of the desired extent of insurance are entered,
a ninth window, in which a summary of the entered data of the insurance and the offered premium appear, which data are corrected and/or confirmed by the policyholder,
a tenth window, in which the general terms and conditions and the general insurance conditions appear, which are confirmed together with the entered data by the policyholder,
an eleventh window, in which the insurance premium is paid online by means of electronic means of payment.

10. The device according to claim 9, wherein the device has a clearing system (CLS) for motor vehicle insurance, in which an electronic insurance certificate is prepared, which is sent online to the responsible permitting authorities, and has an electronic snail sender, whereby the permitting authorities transmits the vehicle registration document to the policyholder.

11. The device according to claim 9, wherein the user databank has a customer dossier implemented as an electronic memory, in which an insurance application and an insurance policy are stored in electronic format (PDF), which appears as a further window on the homepage.
